(19) United States
(12) Patent Application Publication
(10) Pub. No.: US 2012/0295009 A1
(43) Pub. Date: Nov. 22, 2012

(54) OXIDATIVE STABLE OILS AND BLENDS AND COMPOSITIONS CONTAINING SAME

(75) Inventors: Guillermo Napolitano, Dublin, OH (US); Linda J. Erickson, Dublin, OH (US); Antonio J. Gutierrez, Dublin, OH (US); Alexander A. Sher, Dublin, OH (US); Jean-Baptiste Bezelgues, Powell, OH (US)

(73) Assignee: NESTEC S.A., Vevey (CH)

(21) Appl. No.: 13/511,965

(22) PCT Filed: Nov. 22, 2010
(86) PCT No.: PCT/EP2010/067909

§ 371 Date: May 24, 2012

Related U.S. Application Data
(60) Provisional application No. 61/383,154, filed on Sep. 15, 2010.

(30) Foreign Application Priority Data
Nov. 25, 2009 (US) PCT/US09/065944

(51) Int. Cl. A23C 11/02; A23D 9/00

(52) U.S. Cl. 426/602; 426/607; 426/399; 426/601

(57) ABSTRACT

Oxidative stable oils and blends and liquid creamers containing same are provided. Methods for making liquid creamers are also provided. In a general embodiment, the present disclosure provides an oil blend having a final concentration of saturated fatty acids that is no more than 80% by weight of the total oil blend and a concentration of trans fatty acids that is no more than 1% by weight of the total oil blend. The oil blend may include, for example, coconut oil, palm oil, palm oil fractions and high oleic sunflower oil, alone or in combinations thereof. The oil blends may be used in liquid creamers and result in oxidative and emulsion stability for the required shelf life of the liquid creamers.

### BACKGROUND

The present disclosure generally relates to oils and oil blends. More specifically, the present disclosure is directed to oils and blends that may be used in liquid creamers, and methods of making liquid creamers.

Creamers can be in liquid or powder forms and may be dairy or non-dairy based. Non-dairy liquid creamers typically include oil/fat emulsions in water. These products have a relatively long expected shelf-life at room or refrigerated temperatures. However, non-dairy liquid creamers may be susceptible to deterioration due to physical or chemical instability of some of their ingredients or the emulsion as a whole. Accordingly, the oil/fat emulsions used in the liquid creamers are important in achieving the stability of the product.

Traditionally, fats and oils used in non-dairy liquid creamers have a high concentration of saturated and/or trans fatty acids. Both types of fatty acids, however, are known to increase the risk factors for cardiovascular and other chronic diseases. To avoid an increase in risk factors, non-dairy liquid creamers have been made with healthier unsaturated oils. However, the creamers made with unsaturated oils have short shelf lives due to rapid oxidation and development of unpleasant off-flavors.

In view of the previous discussion, there are challenges in creating non-dairy liquid creamers that are oxidative and emulsion stable for a required shelf life, but also contain very low concentrations of trans fatty acids and moderate levels of unsaturated fatty acids.

### SUMMARY

Oxidative and emulsion stable oils and blends and liquid creamers including same are provided. Methods of making liquid creamers are also provided. In a general embodiment, the present disclosure provides oils or blends including at least one oil selected from the group consisting of coconut oil, palm oil, palm oil fractions, high oleic sunflower oil, or combinations thereof. The oils or blends include no more than 80% saturated fatty acids and no more than 1% trans fatty acids by total weight. In another embodiment, the oils or blends include no more than 75% saturated fatty acids by total weight. In yet another embodiment, the oils or blends include no more than 70% saturated fatty acids by total weight.

In an embodiment, the oil blend includes from about 50% to about 80% coconut oil and from about 20% to about 50% high oleic sunflower oil by total weight of the oil blend. The oil blend may include from about 65% to about 75% coconut oil and from about 25% to about 35% high oleic sunflower oil. In another embodiment, the oil blend includes from about 50% to about 70% coconut oil and from about 30% to about 50% high oleic sunflower oil. In an embodiment, the oil blend includes about 67.5% coconut oil and about 32.5% high oleic sunflower oil.

In an embodiment, the oil blend includes from about 20% to about 40% coconut oil, from about 5% to about 25% high oleic sunflower oil, and from about 45% to about 65% palm stearin oil by total weight of the oil blend. The oil blend may include from about 25% to about 35% coconut oil, from about 10% to about 20% high oleic sunflower oil, and from about 50% to about 60% palm stearin oil by total weight of the oil blend. In an embodiment, the oil blend includes about 30% coconut oil, about 15% high oleic sunflower oil, and about 55% palm stearin oil.

In an embodiment, the oil blend includes from about 60% to about 90% palm stearin oil, and from about 10% to about 40% high oleic sunflower oil by total weight of the oil blend. The oil blend may include from about 70% to about 80% palm stearin oil, and from about 20% to about 30% high oleic sunflower oil. In an embodiment, the oil blend includes about 75% palm stearin oil and about 25% high oleic sunflower oil.

In another embodiment a liquid creamer is provided. The liquid creamer includes a gum component, a protein, an emulsifier system, and a lipid phase. The lipid phase includes at least one oil selected from the group consisting of coconut oil, palm oil, palm oil fractions, high oleic sunflower oil, or combinations thereof. The lipid phase also includes no more than 80% saturated fatty acids by total weight of the lipid phase and no more than 1% trans fatty acids by total weight of the lipid phase. In another embodiment, the lipid phase includes no more than 75% saturated fatty acids by total weight. In yet another embodiment, the lipid phase includes no more than 70% saturated fatty acids by total weight.

In an embodiment, the lipid phase includes from about 50% to about 80% coconut oil and from about 20% to about 50% high oleic sunflower oil by total weight of the lipid phase. The lipid phase may include from about 65% to about 75% coconut oil and from about 25% to about 35% high oleic sunflower oil. In another embodiment, the oil blend includes from about 50% to about 70% coconut oil and from about 30% to about 50% high oleic sunflower oil. In an embodiment, the lipid phase includes about 67.5% coconut oil and about 32.5% high oleic sunflower oil.

In an embodiment, the lipid phase includes from about 20% to about 40% coconut oil, from about 5% to about 25% high oleic sunflower oil, and from about 45% to about 65% palm stearin oil by total weight of the oil blend. The lipid phase may include from about 25% to about 35% coconut oil, from about 10% to about 20% high oleic sunflower oil, and from about 50% to about 60% palm stearin oil by total weight of the lipid phase. In an embodiment, the lipid phase includes about 30% coconut oil, about 15% high oleic sunflower oil, and about 55% palm stearin oil.

In an embodiment, the lipid phase includes from about 60% to about 90% palm stearin oil, and from about 10% to about 40% high oleic sunflower oil by total weight of the lipid phase. The lipid phase may include from about 70% to about 80% palm stearin oil, and from about 20% to about 30% high oleic sunflower oil. In an embodiment, the lipid phase includes about 75% palm stearin oil and about 25% high oleic sunflower oil.

In any embodiments of the present disclosure, the liquid creamer includes an ingredient selected from the group consisting of flavors, sweeteners, colorants or combinations thereof.

In another embodiment, a method of making a stable liquid creamer is provided. The method includes hydrating a combination of a gum component, a protein, an emulsifier system, and a lipid phase to form a liquid creamer and aseptically filling a container with the liquid creamer. The lipid phase includes at least one oil selected from the group consisting of coconut oil, palm oil, palm oil fractions, high oleic sunflower oil, or combinations thereof. The lipid phase includes no more than 80% saturated fatty acids by total weight of the lipid phase and no more than 1% trans fatty acids by total weight of the lipid phase. In another embodiment, the lipid phase includes no more than 75% saturated fatty acids by total weight. In yet another embodiment, the lipid phase includes no more than 70% saturated fatty acids by total weight.

In an embodiment, the method includes heat treating the liquid creamer before filling the container.

In an embodiment, the method includes homogenizing the liquid creamer before filling the container.

In an embodiment, the lipid phase includes from about 50% to about 80% coconut oil and from about 20% to about 50% high oleic sunflower oil by total weight of the lipid phase. The lipid phase may include from about 65% to about 75% coconut oil and from about 25% to about 35% high oleic sunflower oil. In another embodiment, the oil blend includes from about 50% to about 70% coconut oil and from about 30% to about 50% high oleic sunflower oil. In an embodiment, the lipid phase includes about 67.5% coconut oil and about 32.5% high oleic sunflower oil.

In an embodiment, the lipid phase includes from about 20% to about 40% coconut oil, from about 5% to about 25% high oleic sunflower oil, and from about 45% to about 65% palm stearin oil by total weight of the lipid phase. The lipid phase may include from about 25% to about 35% coconut oil, from about 10% to about 20% high oleic sunflower oil, and from about 50% to about 60% palm stearin oil by total weight of the oil blend. In an embodiment, the lipid phase includes about 30% coconut oil, about 15% high oleic sunflower oil, and about 55% palm stearin oil.

In an embodiment, the lipid phase includes from about 60% to about 90% palm stearin oil, and from about 10% to about 40% high oleic sunflower oil by total weight of the lipid phase. The lipid phase may include from about 70% to about 80% palm stearin oil, and from about 20% to about 30% high oleic sunflower oil. In an embodiment, the lipid phase includes about 75% palm stearin oil and about 25% high oleic sunflower oil.

An advantage of the present disclosure to provide improved oil blends having low concentrations of trans fatty acids.

Another advantage of the present disclosure is to provide improved oil blends having moderate levels of unsaturated fatty acids.

Still another advantage of the present disclosure is to provide a shelf-stable liquid creamer.

Yet another advantage of the present disclosure is to provide a liquid creamer that is oxidative and emulsion stable.

Another advantage of the present disclosure is to provide a liquid creamer that has a good appearance, aroma, flavor and texture after being stored at room or refrigeration temperature for an extended period of time.

Additional features and advantages are described herein, and will be apparent from, the following Detailed Description.

### BRIEF DESCRIPTION OF THE FIGURES

FIG. 1 is a graph showing sensory scores for a liquid creamer having a reference cotton oil/soy oil blend, palm oil, fractionated palm oil, and a high oleic sunflower oil/coconut oil blend after storage for one month at 20° C.

FIG. 2 is a graph showing sensory scores for a liquid creamer having a reference cotton oil/soy oil blend, palm oil, fractionated palm oil, and a high oleic sunflower oil/coconut oil blend after storage for one month at 30° C.

FIG. 3 is a graph showing sensory scores for a liquid creamer having a reference cotton oil/soy oil blend, palm oil, fractionated palm oil, and a high oleic sunflower oil/coconut oil blend after storage for one month at 38° C.

FIG. 4 is a graph showing sensory scores for a liquid creamer having a reference cotton oil/soy oil blend, a partially hydrogenated high oleic sunflower oil/palm stearin oil/coconut oil blend, a high oleic sunflower oil/palm stearin oil blend, and high oleic sunflower oil at time zero when the oils are fresh after production.

FIG. 5 is a graph showing sensory scores for a liquid creamer having a reference cotton oil/soy oil blend, a high oleic sunflower oil/palm stearin oil blend, and high oleic sunflower oil after storage for one month at 38° C.

FIG. 6 is a graph showing the whiteness (L values) for liquid creamers.

FIG. 7 is a graph showing the whitening capacity in coffee for the liquid creamers of FIG. 6.

### DETAILED DESCRIPTION

The present disclosure relates to oxidative stable oils and oil blends and liquid creamers comprising same. The present disclosure also provides methods of making the liquid creamers. Non-dairy liquid creamers typically consist of an oil/fat emulsion in water. These products have a relatively long expected shelf life at room or refrigerated temperatures (e.g., six months). However, these products are also susceptible to deterioration due to physical and chemical instability of certain ingredients or the emulsion as a whole. Accordingly, the oils and oil blends used in such creamers are an important factor in achieving stability of the product.

Fats and oils used in traditional non-dairy liquid creamers typically have a high concentration of saturated and/or trans fatty acids, both of which are known to increase the risk factors for cardiovascular and other chronic diseases. On the other hand, non-dairy liquid creamers made with healthier unsaturated oils have short shelf lives due to rapid oxidation and the development of unpleasant off-flavors.

It has surprisingly been found that specific oils and mixtures and blends of oils, emulsifiers and lipid antioxidants may produce physically and chemically stable emulsions and products. Specifically, the oil systems may have three basic components including coconut oil, palm oil, and high oleic sunflower oil. The oils may be blended in necessary proportions, or used alone, to ensure maximum oxidation stability, a final concentration of saturated fatty acids that is no more than 80% and a concentration of trans fatty acids that is no more than 1% of the total oil system. In another embodiment, the oils may be blended in necessary proportions, or used alone, to ensure maximum oxidation stability, a final concentration of saturated fatty acids that is no more than 75%. In yet another embodiment, the oils may be blended in necessary proportions, or used alone, to ensure maximum oxidation stability, a final concentration of saturated fatty acids that is no more than 70%. Because the oils of the present disclosure may be used alone or in combination, the phrase “oils/blends” will be used herein to refer to both singular oils and blends of oils.

The oils/blends of the present disclosure may be in any form. For example, the oils/blends may be virgin, refined, hydrogenated, partially hydrogenated, fractionated (e.g., stearin, olein, etc.), partially fractionated, etc. In an embodiment, the oils/blends of the present disclosure include palm oil fractions. In another embodiment, the oils/blends include partially hydrogenated high oleic sunflower oil. In yet another embodiment, the oils/blends include palm stearin. The skilled artisan will immediately appreciate that any of the coconut oil, palm oil, or high oleic sunflower oils may be present in any of the above-mentioned forms.

Further, the oils/blends of the present disclosure, may naturally include certain desirable non-glyceride components such as, but not limited to, free fatty acids, phospholipids, carotenoids, tocopherols, tocotrienols, etc. For example, high oleic sunflower oil and palm oils may contain tocopherols, mixtures of tocopherols and ascorbyl palmitate as lipid antioxidants, respectively.

The oils/blends of the present disclosure may be used in any amounts necessary to achieve a final concentration of saturated fatty acids that is no more than 80% and a concentration of trans fatty acids that is no more than 1% by weight of the total oils/blends. For example, in an embodiment, an oil/blend of the present disclosure may comprise 100% palm oil. In another embodiment, an oil/blend of the present disclosure may comprise 100% soft palm mid-fraction. In yet another embodiment, an oil/blend of the present disclosure may comprise 100% high oleic sunflower oil.

Alternatively, the coconut, palm and sunflower oils may be combined in necessary proportions and blends to achieve the specific fatty acids amounts discussed above. For example, in an embodiment an oil blend may include from about 50% to about 80% coconut oil and from about 20% to about 50% high oleic sunflower oil by total weight of the oil blend. The oil blends may include from about 65% to about 75% coconut oil and from about 25% to about 35% high oleic sunflower oil. In another embodiment, the oil blend includes from about 50% to about 70% coconut oil and from about 30% to about 50% high oleic sunflower oil. More specifically, the oil blends may include about 67.5% coconut oil and about 32.5% high oleic sunflower oil.

In another embodiment, the oil blends may include from about 20% to about 40% coconut oil, from about 5% to about 25% high oleic sunflower oil, and from about 45% to about 65% palm stearin oil by total weight of the oil blend. The oil blends may include from about 25% to about 35% coconut oil, from about 10% to about 20% high oleic sunflower oil, and from about 50% to about 60% palm stearin oil by total weight of the oil blend. The oil blends may also include about 30% coconut oil, about 15% high oleic sunflower oil, and about 55% palm stearin oil.

In yet another embodiment, the oil blends may include from about 60% to about 90% palm stearin oil, and from about 10% to about 40% high oleic sunflower oil by total weight of the oil blend. The oil blends may include from about 70% to about 80% palm stearin oil, and from about 20% to about 30% high oleic sunflower oil. The oil blends may also include about 75% palm stearin oil and about 25% high oleic sunflower oil. The skilled artisan will appreciate that any combinations of oils disclosed in the present application may be used to achieve a final concentration of saturated fatty acids that is no more than 80% (or no more than 75% or no more than 70%) by weight and a concentration of trans fatty acids that is no more than 1% by weight of the total oils/blends.

As discussed previously, the oils/blends of the present disclosure may be used in stable non-dairy liquid creamers that include, for example, a gum component, a protein and an emulsifier system. The liquid creamers can be shelf-stable and aseptic. Such liquid creamers can be generally described as oil-in-water emulsions, with an aqueous continuous phase and an oily disperse phase. As used herein, the term “stable” means remaining in a state or condition having minimal phase separation (e.g. creaming, sedimentation, age gelation) for an extended period of time (e.g., for at least 1 month). Stable liquid creamers according to embodiments of the present disclosure can be found to be stable when maintained for at least 1 month, and are generally stable from 2 to 3 months or longer without feathering, flocculation, sedimentation or other phase separation issues (e.g., creaming, age gelation, etc.) during different storage conditions over the full life of the liquid creamer. The stable liquid creamers can have a shelf-life stability, for example, for at least nine months at 20° C., 6 months at 30° C., and 1 month at 38° C. The liquid creamers can have high whitening capacity and a pleasant mouthfeel.

The non-dairy liquid creamer composition has a gum component including a blend of kappa carrageenan and iota carrageenan in a weight ratio of about 1:2 to about 1:6, a protein ranging from about 0.5% to about 2.5% by weight, an emulsifier system including a blend of at least two emulsifiers and ranging from about 0.2 to about 0.7% by weight, and a lipid phase ranging from about 8% to about 20% by weight of the non-dairy liquid creamer composition. The weight ratio among the emulsifier system:protein:gum component is (2 to 14):(5-50):1.

The gum component of the liquid creamer may include a blend of kappa carrageenan and iota carrageenan. In an embodiment, the gum component ranges from about 0.05% to about 0.10% by weight. Additionally, the protein component of the liquid creamer may include any suitable protein known to the skilled artisan. For example, the protein can be casein, sodium caseinate, potassium caseinate, calcium caseinate, soy protein, pea protein, whey protein or any combination thereof.

The emulsifier system of the liquid creamer can include a combination of at least two low molecular weight emulsifiers at specific ratios. The type of emulsion can be controlled by the emulsifiers, and the emulsifiers should be soluble in the continuous phase. For stable oil in water emulsion, typically emulsifiers with high hydrophilic-lipophilic balance (“HLB”) values should provide the best stability. However, it was surprisingly found that the combination of low molecular weight emulsifiers with low and medium HLB values provided the best emulsion stability of liquid creamers at the specific ratios between the emulsifiers with low and medium HLB values.

The hydrophilicity and lipophilicity are different among emulsifiers, and the balance between the two is called the HLB value. The HLB value is determined by calculating hydrophilic or lipophilic values of the different regions of the molecule. Various references relate to the HLB value. Examples are Griffin WC: “Classification of Surface-Active Agents by ‘HLB,’” Journal of the Society of Cosmetic Chemists 1 (1949:311, or Griffin W C: “Calculation of HLB Values of Non-Ionic Surfactants,” Journal of the Society of Cosmetic Chemists 5 (1954): 259. The HLB value of an emulsifier typically ranges from 0 to 20.

Low HLB values range from about 1 to about 4. Medium HLB values range from about 5 to about 10. Low molecular weight emulsifiers with low HLB values can include, but are not limited to, monoglycerides, diglycerides, acetylated monoglycerides, sorbitan trioleate, glycerol dioleate, sorbitan tristearate, propyleneglycol monostearate, glycerol monooleate and monostearate, alone or in combination. The low molecular weight emulsifiers with medium HLB values can include, but are not limited to, sorbitan monooleate, propylene glycol monolaurate, sorbitan monostearate, calcium stearoxyl-2-lactylate, glycerol sorbitan monopalmitate, soy lecithin, and diacetylated tartaric acid esters of monoglycerides, alone or in combination. In an embodiment, the emulsifiers are monoglycerides (“MG”), diglycerides (“DG”), diacetyl tartaric acid esters of monoglycerides (“TMG”) or a combination thereof having low or medium HLB values.

The liquid creamer composition comprises a lipid phase. The lipid phase comprises an oil blend of the present disclosure. The oil blend provides creaminess and mouthfeel to the creamer. It also participates in the whitening effect of the creamer.

In an embodiment, the liquid creamer excludes a cellulose. For example, the liquid creamers can be made without using any cellulose ingredients such as microcrystalline cellulose and carboxy-methyl cellulose.

In an embodiment, the liquid creamer includes a buffering agent. The buffering agent prevents undesired creaming or precipitation of the creamer upon addition into a hot, acidic environment, such as coffee. The buffering agent can be, for example, monophosphates, diphosphates, sodium mono- and bicarbonates, potassium mono- and bicarbonates or a combination thereof. More specifically, non-limiting examples of suitable buffers are salts such as potassium phosphate, dipotassium phosphate, potassium hydrophosphate, sodium bicarbonate, sodium citrate, sodium phosphate, disodium phosphate, sodium hydrophosphate, and sodium tripolyphosphate. The buffer can be present in an amount of about 0.5 to about 1% of the total weight of the liquid creamer.

Whitening agents may also be used in the liquid creamer. Whitening agents may be included in an amount sufficient to provide further whitening to an aqueous media to which the liquid creamer is added. For example, the whitening agent can be TiO₂, which can be present in an amount of about 0.1% to about 1% by weight of the composition. The TiO₂ can have a particle size ranging from about 0.1 to about 0.7 microns, with a preferred embodiment having a particle size of 0.4 microns. When TiO₂ is used as a complementary whitener, the TiO₂ can be maintained in full suspension throughout the liquid creamer shelf-life. In an embodiment, the liquid creamer composition does not contain TiO₂.

The particulate size range of a whitening agent is of between 0.3 and 0.5 microns. The optimum size of the whitening component is obtained when light scattering is delivering the most intense white color. This is related to the wavelength considered and for the whole visible spectrum the optimum size would be half the average wavelength or around 0.30 microns. It may be expected that a smaller size would make the liquid creamer itself bluish in color, whereas a larger size would progressively decrease the whitening power.

Using a particle size around a mean of 0.30 microns should be beneficial at least on two accounts. The increased whitening power results in less of the whitening component needed for the same end color, which allows for a cost reduction. The smaller particles are easier to suspend and keep suspended. Generally speaking, suspended particles are governed by the Stokes' law terminal velocity in term of gravitational force providing a tendency for settling. However, at particle size lower than about 2.0 microns, other forces become significant and also control the settling or suspension. It is well known that below 2.0 microns Brownian motion predominates and the gravitational forces becomes less and less important as the size is reduced, thus favoring suspension of small particles without much settling.

The liquid creamer can also include one or more ingredients such as flavors, sweeteners, colorants or combinations thereof. Sweeteners can include, for example, sucrose, fructose, dextrose, maltose, dextrin, levulose, tagatose, galactose, corn syrup solids and other natural or artificial sweeteners. Sugarless sweeteners can include, but are not limited to, sugar alcohols such maltitol, xylitol, sorbitol, erythritol, mannitol, isomalt, lactitol, hydrogenated starch hydrolysates, and the like, alone or in combination.

Usage level of the flavors, sweeteners and colorants will vary greatly and will depend on such factors as potency of the sweetener, desired sweetness of the product, level and type of flavor used and cost considerations. Combinations of sugar and/or sugarless sweeteners may be used in the liquid creamers. In an embodiment, the sweetener is present in the liquid creamer at a concentration ranging from about 20% to 50% by weight. In another embodiment, the sweetener ranges from about 25% to 35% by weight.

The stable liquid creamers in embodiments of the present disclosure can be easily dispersible in coffee and stable in hot and cold acidic environments. When added to coffee, tea, cocoa or other liquid products, the liquid creamers can provide a high whitening capacity, a good mouthfeel, full body, smooth texture, and also a good flavor with no off-flavor notes developed during storage time. The liquid creamers may also be used with other various food products such as cereals, as cream for berries, creamers for soups and in many cooking applications.

The liquid creamer can be added to any suitable beverage in an amount sufficient to provide a creaming effect to the beverage. A creaming effect imparts qualities associated with cream or dairy such as desirable, flavor, texture, body, and/or color (lightening or whitening). In alternative embodiments, the liquid creamers are stable and overcome phase separation issues (e.g., creaming, plugging, gelation, syneresis, sedimentation, etc.) during storage at refrigeration temperatures (e.g., ˜4° C.), room temperatures (e.g., ˜20° C.) and elevated temperatures (e.g., ˜30 to 38° C.).

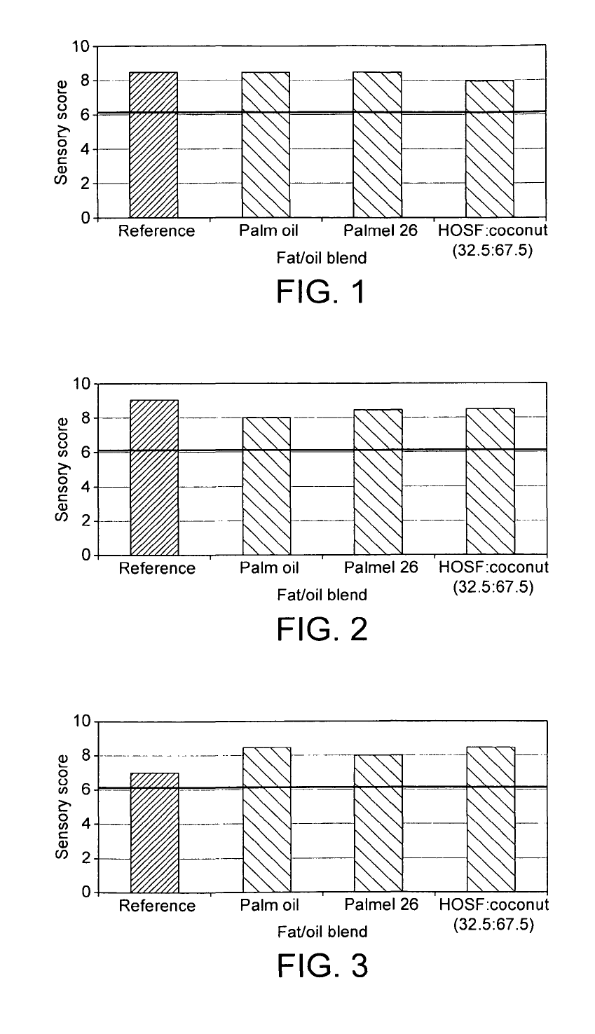

FIGS. 1-5 clearly illustrate that the oils/blends of the present disclosure provide acceptable sensory scores when used in non-dairy liquid creamers even after storage of the liquid creamers for different amounts of time and at different temperatures. The sensory scores were obtained by consensus of 5-6 trained panelists, who rated the taste of the non-dairy liquid creamers in coffee. The panelists rated the non-dairy liquid creamer based on several key sensory attributes including, for example, appearance, aroma, flavor and texture. The horizontal line running across the graphs indicates a minimum acceptable sensory score.

For example, FIGS. 1-3 illustrate graphs of sensory scores for coffee having a non-dairy liquid creamer therein that included several exemplary oils/blends of the present disclosure. The first oil labeled “reference” is a blend of a partially hydrogenated cottonseed and soybean oils currently used in liquid creamers on the market. The second oil is a palm oil. The third oil is a palm oil fraction. The fourth oil is a blend of 32.5% high oleic sunflower oil and 67.5% coconut oil. The oils of FIG. 1 were included in non-dairy liquid creamers, which were stored for one month at 20° C. prior to introduction into the coffee. The oils of FIG. 2 were included in non-dairy liquid creamers, which were stored for one month at 30° C. prior to introduction into the coffee. The oils of FIG. 3 were included in non-dairy liquid creamers, which were stored for one month at 38° C. prior to introduction into the coffee.

As is clearly indicated by FIGS. 1-3, most of the creamers having oils/blends of the present disclosure exceeded the minimum acceptable sensory scores when used in coffee. Indeed, most of the creamers represented by the oils/blends of FIGS. 1-3 achieved sensory scores were similar to, or exceeded, that of the reference oil blend.

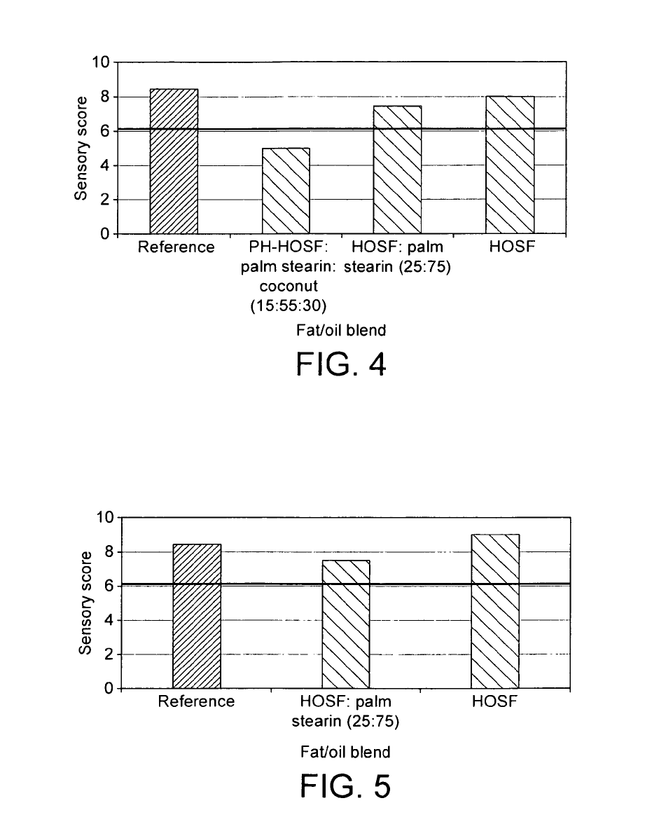

Similarly, FIGS. 4-5 illustrate graphs of sensory scores for coffee having a non-dairy liquid creamer therein that included several exemplary oils/blends of the present disclosure. The first oil labeled “reference” is a blend of a partially hydrogenated cottonseed and soybean oils currently used in liquid creamers on the market. The second oil is a blend of 15% partially hydrogenated high oleic sunflower oil, 30% coconut oil, and 55% palm stearin oil. The third oil is a blend of 25% high oleic sunflower oil and 75% palm stearin oil. The fourth oil is a high oleic sunflower oil. The oils/blends of FIG. 4 were included in a non-dairy liquid creamer that was not stored prior to introduction into the coffee. In other words, the oils/blends were introduced into a creamer, which was immediately used for sensory evaluation in coffee. The oils/blends of FIG. 5 were included in non-dairy liquid creamers, which were stored for one month at 38° C. prior to introduction into the coffee.

As is clearly indicated by FIGS. 4-5, all of the creamers having oils/blends of the present disclosure exceeded the minimum acceptable sensory scores when used in coffee. Indeed, all of the creamers represented by oils/blends of FIGS. 4-5 achieved similar sensory scores to the sensory scores of the reference oil blend. Accordingly, the Figures make clear that the sensory scores of the proposed oils and blends are at least acceptable and, in most case, much better than simply acceptable.

The present disclosure also provides methods of making a stable liquid creamer using the presently disclosed oxidative/emulsion stable oils/blends. Advantageously, in alternative embodiments, the stable liquid creamers can have a shelf-life stability, for example, for at least six months at room or refrigerated temperatures.

The methods of making a liquid creamer include hydrating a combination of a gum component, a protein, an emulsifier system, and a lipid phase to form a liquid creamer, homogenizing the liquid creamer; and aseptically filling a container with the liquid creamer. The lipid phase includes at least one oil selected from the group consisting of coconut oil, palm oil, palm oil fractions, high oleic sunflower oil, and combinations thereof, wherein the lipid phase comprises no more than 80% saturated fatty acids by total weight of the lipid phase, and no more than 1% trans fatty acids by total weight of the lipid phase. In another embodiment of the method, the lipid phase comprises no more than 75% saturated fatty acids by total weight. In yet another embodiment of the method, the lipid phase comprises no more than 70% saturated fatty acids by total weight.

The hydrating can be done with water or any other suitable liquid. For example, the hydration of gums, emulsifiers, proteins, buffer(s), sweetener(s) and flavor(s) in water can be done under agitation with the addition of melted oil/fat, followed by heat treatment, homogenization, cooling and filling aseptic containers under aseptic conditions. Aseptic heat treatment may use direct or indirect ultra high temperature (“UHT”) processes. The homogenization could be performed before and/or after heat treatment.

The oils/blends of the present disclosure include very low concentrations of trans fatty acids and a moderate level of unsaturated fatty acids, while at the same time having oxidative and emulsion stability that provides for an elongated shelf life. When added to a non-dairy liquid creamer, the oils/blends of the present disclosure provide a physically and chemically stable liquid creamer. The use of the liquid creamers is not limited to coffee applications. For example, the creamers can also be used for other beverages, such as tea or cocoa, or used with cereals or berries, creamers for soups, and in many cooking applications, etc.

### EXAMPLES

By way of example and not limitation, the following examples are illustrative of various embodiments of the present disclosure.

A dry blend of carrageenan with sucrose was prepared by mixing together sucrose with kappa-carrageenan and iota-carrageenan in a weight ratio of 1:3. The dry blend was added into hot water at about 75° C., under high agitation in a tank. Then, di-potassium phosphate was added to the tank under continuous agitation.

Next, a dry blend was prepared by mixing together sodium caseinate, and sucrose. The dry blend was added to the tank under high agitation. After about 10 minutes of mixing, emulsifiers were added into the tank under continuous high agitation. Further, melted oil blend at about 60° C. was added under high agitation, followed by the rest of sucrose. Small amount of additional water was added to adjust the total product weight to 100 kg. Proportions for the different components of the creamer composition are given in Table 1 below.

TABLE 1

| | Ref. | FFa-01 | FFa-02 | FFa-03 | FFa-04 | FFa-05 | FFa-06 |
|---|---|---|---|---|---|---|---|
| Ingredient | % | % | % | % | % | % | % |
| Water | 59.86 | 57.16 | 57.19 | 56.16 | 56.16 | 58.16 | 56.03 |
| Sugar | 30.00 | 30.00 | 30.00 | 30.00 | 30.00 | 30.00 | 30.00 |
| P.H. soybean/ | 8.30 | 11.00 | 11.00 | | | | 12.00 |
| cottonseed oil | | | | | | | |
| Palm oil | | | | 12.00 | | | |
| HOSF:palm olein | | | | | 12.00 | | |
| (50:50) | | | | | | | |
| HOSF:palm | | | | | | 10.00 | |
| stearin (50:50) | | | | | | | |
| Anhydrous | 0.40 | 0.40 | 0.40 | 0.40 | 0.40 | 0.40 | 0.40 |
| dipotassium | | | | | | | |
| phosphate | | | | | | | |
| Sodium caseinate | 1.00 | 1.00 | 1.00 | 1.00 | 1.00 | 1.00 | 1.00 |
| (Alanate 180) | | | | | | | |
| Panodan 150K | 0.30 | 0.30 | 0.30 | 0.30 | 0.30 | 0.30 | 0.40 |
| Dimodan HS | 0.10 | 0.10 | 0.10 | 0.10 | 0.10 | 0.10 | 0.13 |
| Carraggeenan | 0.04 | 0.04 | 0.01 | 0.04 | 0.04 | 0.04 | 0.04 |
| Total | 100 | 100 | 100 | 100 | 100 | 100 | 100 |

The resulting liquid was pre-heated, UHT treated for 5 seconds at 143° C., homogenized at 180/40 bar, cooled and the liquid creamer was aseptically filled into bottles. Liquid creamers can also be aseptically filled in any aseptic containers, e.g., jars, jugs or pouches.

Preparation of coffee with the creamer composition: A 1.2% coffee beverage was prepared with instant coffee powder (e.g., Taster Choice®, French roasted, freeze dried). Whitened coffee samples were prepared by adding 30 g of creamer composition to 180 ml of black coffee solution at 85° C.

Whitening capacity: Color L, a, and b values of the coffee with CML were determined using Colorimeter, Model ColorQuest XE.

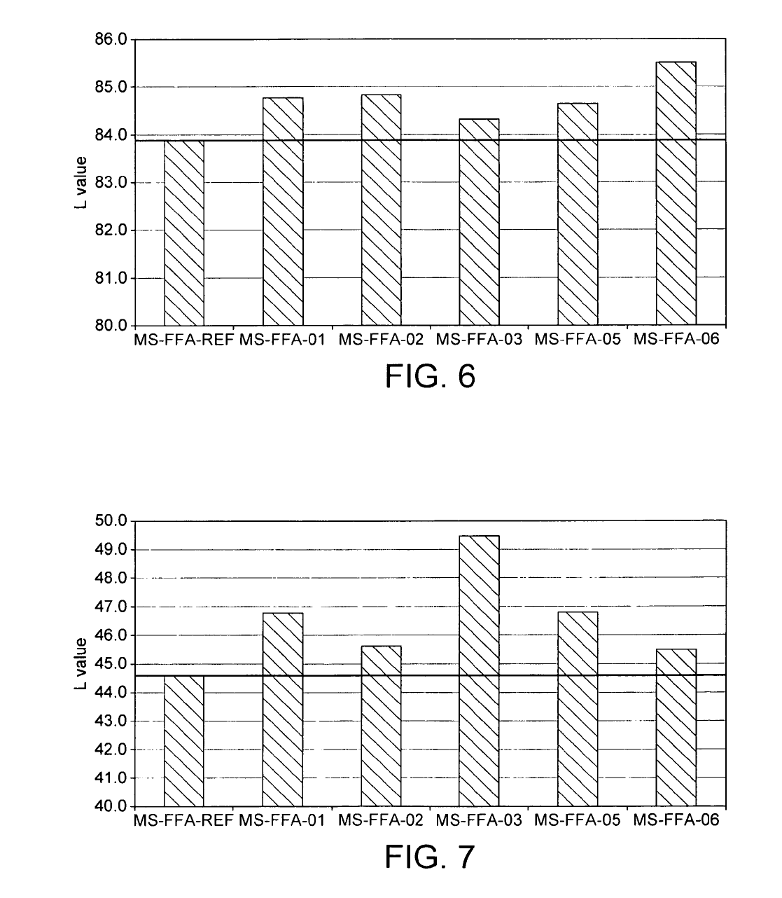

Whiteness of the creamer composition samples containing different oil blends with low TFA and without added TiO₂ are shown in FIG. 6. Increase in oil level in the creamer, results in higher L value as compared to that of the reference.

Whitening capacity of the creamer composition in coffee is shown in FIG. 7. The higher whitening capacity of the creamer composition was achieved with MS-FFA-03. It is interesting to see that the whitening effect of the different oil blend in the pure creamer product does not correspond with the whitening effect in coffee.

Physico-chemical stability and sensory profile of creamer and coffee beverage with added liquid creamer were judged by non-trained panelists. No phase separation (e.g., creaming, de-oiling, marbling, etc), gelation, sedimentation and practically no viscosity changes were found during the storage.

It was found that the liquid creamer has good appearance, mouth-feel, smooth texture and a good flavor without an “off” taste. Further, the creamer showed high whitening capacity when added to a coffee.

All percentages expressed herein relating to the components of a composition are by weight of the total weight of the composition unless expressed otherwise. As used throughout, ranges are used herein in shorthand, so as to avoid having to set out at length and describe each and every value within the range. Any appropriate value within the range can be selected, where appropriate, as the upper value, lower value, or the terminus of the range.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. An oil blend comprising:
at least one oil selected from the group consisting of coconut oil, palm oil, palm oil fractions, high oleic sunflower oil, and combinations thereof, the blend comprises no more than 80% by weight saturated fatty acids, and no more than 1% by weight trans fatty acids.

2. The oil blend of claim 1, comprising from about 50% to about 80% coconut oil and from about 20% to about 50% high oleic sunflower oil by total weight of the oil blend.

3. The oil blend of claim 1, comprising from about 20% to about 40% coconut oil, from about 5% to about 25% high oleic sunflower oil, and from about 45% to about 65% palm stearin oil by total weight of the oil blend.

4. The oil blend of claim 1, comprising from about 60% to about 90% palm stearin oil, and from about 10% to about 40% high oleic sunflower oil by total weight of the oil blend.

5. The oil blend of claim 1, comprising from about 50% to about 70% coconut oil and from about 30% to about 50% high oleic sunflower oil by total weight of the oil blend.

6. The oil blend of claim 1, wherein the blend comprises no more than 75% by weight saturated fatty acids.

7. The oil blend of claim 1, wherein the blend comprises no more than 70% by weight saturated fatty acids.

8. The oil blend of claim 1, comprising an ingredient selected from the group consisting of flavors, sweeteners, colorants and combinations thereof.

9. A liquid creamer comprising:
a gum component;
a protein;
an emulsifier system; and
a lipid phase comprising at least one oil selected from the group consisting of coconut oil, palm oil, palm oil fractions, high oleic sunflower oil, and combinations thereof, the lipid phase comprises no more than 80% saturated fatty acids by total weight of the lipid phase, and no more than 1% trans fatty acids by total weight of the lipid phase.

10. The liquid creamer of claim 9, the lipid phase comprising from about 50% to about 80% coconut oil and from about 20% to about 50% high oleic sunflower oil by total weight of the lipid phase.

11. The liquid creamer of claim 9, the lipid phase comprising from about 20% to about 40% coconut oil, from about 5% to about 25% high oleic sunflower oil, and from about 45% to about 65% palm stearin oil by total weight of the lipid phase.

12. The liquid creamer of claim 9, the lipid phase comprising from about 60% to about 90% palm stearin oil, and from about 10% to about 40% high oleic sunflower oil by total weight of the lipid phase.

13. The liquid creamer of claim 9, comprising from about 50% to about 70% coconut oil and from about 30% to about 50% high oleic sunflower oil by total weight of the lipid phase.

14. The liquid creamer of claim 9, wherein the lipid phase comprises no more than 80% saturated fatty acids by total weight of the lipid phase.

15. The liquid creamer of claim 9, wherein the lipid phase comprises no more than 80% saturated fatty acids by total weight of the lipid phase.

16. The liquid creamer of claim 9, comprising an ingredient selected from the group consisting of flavors, sweeteners, colorants and combinations thereof.

17. A method of making a stable liquid creamer comprising:
hydrating a combination of a gum component, a protein, an emulsifier system, and a lipid phase, the lipid phase comprising at least one oil selected from the group consisting of coconut oil, palm oil, palm oil fractions, high oleic sunflower oil, and combinations thereof, wherein the lipid phase comprises no more than 80% saturated fatty acids by total weight of the lipid phase, and no more than 1% trans fatty acids by total weight of the lipid phase, to form a liquid creamer;
homogenizing the liquid creamer; and
aseptically filling a container with the liquid creamer.

18. The method of claim 17, comprising heat treating the liquid creamer before filling the container.

19. The method of claim 17, comprising homogenizing the liquid creamer before filling the container.

20. The method of claim 17, wherein the lipid phase comprises from about 50% to about 80% coconut oil and from about 20% to about 50% high oleic sunflower oil by total weight of the lipid phase.

21. The method of claim 17, wherein the lipid phase comprises from about 20% to about 40% coconut oil, from about 5% to about 25% high oleic sunflower oil, and from about 45% to about 65% palm stearin oil by total weight of the lipid phase.

22. The method of claim 17, wherein the lipid phase comprises from about 60% to about 90% palm stearin oil, and from about 10% to about 40% high oleic sunflower oil by total weight of the lipid phase.

23. The method of claim 17, wherein the lipid phase comprises from about 50% to about 70% coconut oil and from about 30% to about 50% high oleic sunflower oil by total weight of the lipid phase.

24. The method of claim 17, wherein the lipid phase comprises no more than 75% saturated fatty acids by total weight of the lipid phase.

25. The method of claim 17, wherein the lipid phase comprises no more than 70% saturated fatty acids by total weight of the lipid phase.
